(19) United States
(12) Patent Application Publication
(10) Pub. No.: US 2026/0264284 A1
(43) Pub. Date: Sep. 10, 2026

(54) CUT-OFF TOOL AND SHROUD ASSEMBLY

(71) Applicant: MILWAUKEE ELECTRIC TOOL CORPORATION, Brookfield, WI (US)

(72) Inventors: Ryan T. Gallagher, Mukwonago, WI (US); David A. Bierdeman, New Berlin, WI (US)

(21) Appl. No.: 19/561,016

(22) Filed: Mar. 9, 2026

Related U.S. Application Data
(60) Provisional application No. 63/769,518, filed on Mar. 10, 2025.

(51) Int. Cl. B27B 9/02; B23D 59/00; B27G 19/02; B27G 19/04

(52) U.S. Cl. CPC B27B 9/02; B23D 59/0064; B27G 19/025; B27G 19/04

(57) ABSTRACT

An assembly includes a cut-off tool and a shroud. The cut-off tool including a motor housing, a pistol-grip handle, an arbor, a cutting disk attachable to the arbor and rotatable about a cutting disk axis, and a guard. The shroud being coupled with the guard and including a shoe configured to support the shroud on a workpiece, a periphery of the shoe defining a shoe profile in a frame of reference parallel with the workpiece with the shoe supported on the workpiece, a depth adjustment bracket coupled to the shoe, a shroud body engageable with and surrounding the guard, the shroud body being pivotably coupled to the shoe to adjust a cut depth of the cutting disk below the shoe, and a lever arm extending between the shroud body and the depth adjustment bracket. The lever arm and the depth adjustment bracket are positioned entirely within the shoe profile.

### CROSS-REFERENCE TO RELATED APPLICATIONS

This application claims priority to U.S. Provisional Patent Application No. 63/769,518 filed on Mar. 10, 2025, the entire content of which is incorporated herein by reference.

### FIELD OF THE INVENTION

The present disclosure relates to power tool and shroud assemblies, and more specifically to a compact multi-material cut-off tool and shroud assembly.

### BACKGROUND OF THE INVENTION

Cut-off tools or other power tools such as saws, grinders, or the like may operate in tight spaces to cut a workpiece. Such tools or tool assemblies may include shoes that translate along rulers to generate straight cuts in workpieces. Debris generated may be funneled to a vacuum source by a shroud. Some tool and shroud assemblies permit user adjustment of how much a disk or other cutting element is exposed.

### SUMMARY OF THE INVENTION

The present disclosure provides, in one aspect, a cut-off tool and shroud assembly including: a cut-off tool including a motor housing in which an electric motor is received, a pistol-grip handle extending from the motor housing in a transverse direction, an arbor rotatably supported by the motor housing, a cutting disk attachable to the arbor and rotatable about a cutting disk axis, and a guard surrounding an upper portion of the cutting disk; and a shroud coupled with the guard, the shroud including a shoe configured to support the shroud on a workpiece, a periphery of the shoe defining a shoe profile in a frame of reference parallel with the workpiece with the shoe supported on the workpiece, a depth adjustment bracket coupled to the shoe, a shroud body engageable with and surrounding the guard, the shroud body being pivotably coupled to the shoe about a pivot axis to adjust a cut depth of the cutting disk below the shoe, and a lever arm extending from the shroud body between the shroud body and the depth adjustment bracket; wherein the lever arm and the depth adjustment bracket are positioned entirely within the shoe profile.

The present disclosure provides, in another aspect, a cut-off tool and shroud assembly including: a cut-off tool including a motor housing in which an electric motor is received, a pistol-grip handle extending from the motor housing in a transverse direction, an arbor rotatably supported by the motor housing, a cutting disk attachable to the arbor and rotatable about a cutting disk axis, and a guard surrounding an upper portion of the cutting disk; and a shroud coupled with the guard, the shroud including a shoe configured to support the shroud on a workpiece, a periphery of the shoe defining a shoe profile pein a frame of reference parallel with the workpiece with the shoe supported on the workpiece, a depth adjustment bracket coupled to the shoe, a shroud body engageable with and surrounding the guard, the shroud body being pivotably coupled to the shoe about a pivot axis to adjust a cut depth of the cutting disk below the shoe, and a retention device selectively movable between a locked position, in which the shroud body is secured relative to the shoe, and an unlocked position, in which the shroud body is pivotable relative to the shoe; wherein the retention device is positioned entirely within the shoe profile.

The present disclosure provides, in another aspect, a cut-off tool and shroud assembly including: a cut-off tool including a motor housing in which an electric motor is received, a pistol-grip handle extending from the motor housing in a transverse direction, an arbor rotatably supported by the motor housing, a cutting disk attachable to the arbor and rotatable about a cutting disk axis, a guard surrounding an upper portion of the cutting disk, a shroud coupled with the guard, the shroud including a shoe configured to support the shroud on a workpiece, a depth adjustment bracket coupled to the shoe; a shroud body engageable with and surrounding the guard, the shroud body defining an uppermost surface as viewed in a frame of reference parallel with the cutting disk axis, and a latch movably coupled to the shroud body, the latch including an actuator extending above the uppermost surface of the shroud body, the actuator configured to receive an input force to move the latch to an unlocked position in which the shroud is removable from the guard.

Other features and aspects of the invention will become apparent by consideration of the following detailed description and accompanying drawings.

### BRIEF DESCRIPTION OF THE DRAWINGS

FIG. 1 is a perspective view of a known cut-off tool and shroud assembly.

FIG. 2 is a side view of the cut-off tool and shroud assembly of FIG. 1.

FIG. 3 is a section view of the cut-off tool and shroud assembly taken along section line 3-3 in FIG. 1.

FIG. 4 is a section view of the cut-off tool and shroud assembly taken perpendicular to a cutting disk rotation axis.

FIG. 5 is a perspective view of cut-off tool and shroud assembly according to an embodiment of the disclosure.

FIG. 6 is a section view of the cut-off tool and shroud assembly of FIG. 5 taken perpendicular to a cutting disk rotation axis thereof.

FIG. 7 is a top view of the cut-off tool and shroud assembly of FIG. 5.

FIG. 8 is a perspective view of another cut-off tool and shroud assembly.

FIG. 9 is side view of the cut-off tool and shroud assembly of FIG. 8.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

FIGS. 1-4 illustrate a known cut-off tool and shroud assembly 4 including a cut-off tool 10 and a shroud 100 coupled to the cut-off tool 10. The cut-off tool 10 is a compact multi-material including a housing 14, an electric motor 16 received (i.e., positioned) within a motor portion (i.e., a motor housing) 18 of the housing 14, and an arbor 22 driven by the motor 16 to which a relatively small diameter (e.g., 3 inch, although other sizes are viable) cutting or grinding disk (hereinafter, “cutting disk 24”) is attachable. The arbor 22 is generally supported by the housing 14 and is capable of relative movement therewith (e.g., translation of the arbor 22 and cutting disk 24 along a workpiece W). The housing 14 also includes a pistol-grip handle portion 26 extending transversely from the motor portion 18 and terminating at a receptacle 30 in which a battery pack B is received. In the illustrated embodiment, the motor 16 and the arbor 22 are oriented along a rotation axis RA with the cutting disk 24 oriented generally perpendicularly to the rotation axis RA (i.e., cutting disk axis). In some embodiments, the motor 16 and arbor 22 may rotate about different axes (e.g., offset axes). The handle portion 26 extends along a longitudinal axis LA with the rotation axis RA of the motor 16 and the arbor 22 is generally perpendicular (i.e., plus or minus about 10 degrees relative to an orthogonal) to a longitudinal axis LA of the handle portion 26.

The cut-off tool 10 also includes a trigger 34 protruding from the handle portion 26 of the housing 14, permitting a user to grasp the handle portion 26 for maneuvering the cut-off tool 10 (without an auxiliary handle) while depressing the trigger 34 to activate the motor 16. The cut-off tool 10 further includes a forward/reverse selector shuttle 38 located proximate the front of the handle portion 26 and forward of the trigger 34, permitting an operator to select either a forward or reverse rotational direction of the motor 16 with their thumb, for example, while maintaining their grasp on the handle portion 26 with their index finger on the trigger 34. Upon activation of the trigger 34, power is supplied to the motor 16 from the battery pack B, and the cut-off tool 10 may be driven in a forward cutting direction F with the motor 16 rotating in a forward direction and, conversely, the cut-off tool 10 may be driven in a reverse cutting direction R when the motor 16 is in the reverse direction. A position of the forward/reverse selector shuttle 38 relative to “F” and “R” indicators on the housing 14 and optionally the shroud 60 may indicate to the user the selected forward or reverse rotational direction of the motor 16.

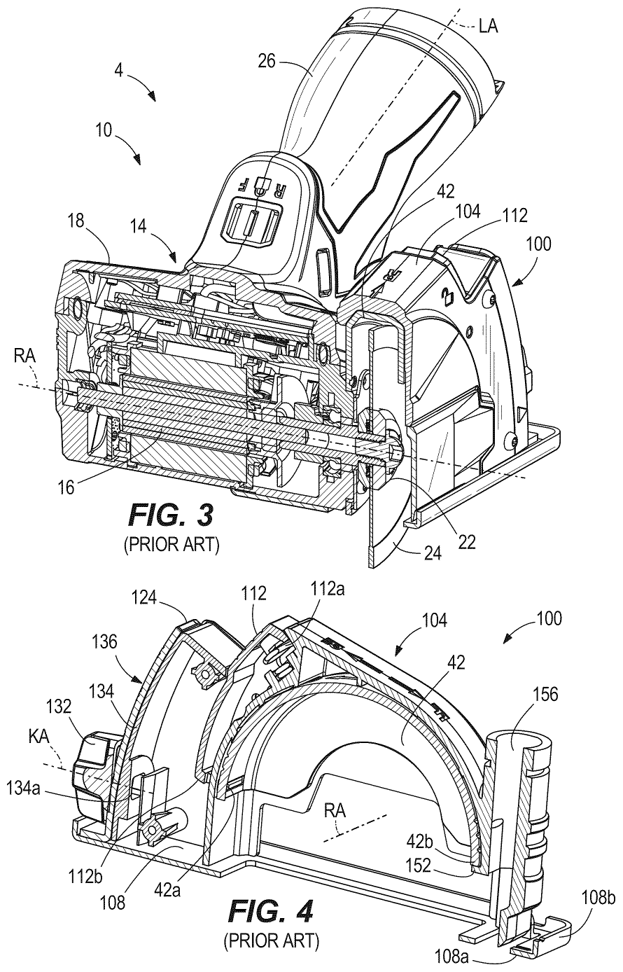

The cut-off tool 10 further includes a guard 42 (FIG. 3) configured to shield the user from any debris and/or sparks generated by the cutting disk 24 during operation of the cut-off tool 10. Orientation of the guard 42 may be selectively adjustable and secured in any one of a plurality of different positions relative to the motor portion 18 (e.g., by a detent mechanism) about the rotation axis RA of the arbor 22 to permit the user to shield different portions of the surroundings of the cut-off tool 10 from the debris and/or sparks.

The shroud 100 includes a shroud body 104 and a shoe 108 configured to support the shroud on the workpiece W. The shroud body 104 is attachable to the guard 42 via a latch 112. The shoe 108 permits level sliding of the cut-off tool 10 along a top surface of the workpiece W and includes a generally planar plate 108a and a plurality of sidewalls 108b upstanding from the plate 108a. In the illustrated embodiment, the sidewalls 108b extend upwardly from the plate 108a only from a portion of a generally rectangular periphery of the shoe 108. Other embodiments may have other shapes of differing arrangements of sidewalls 108b, or no sidewalls 108b at all.

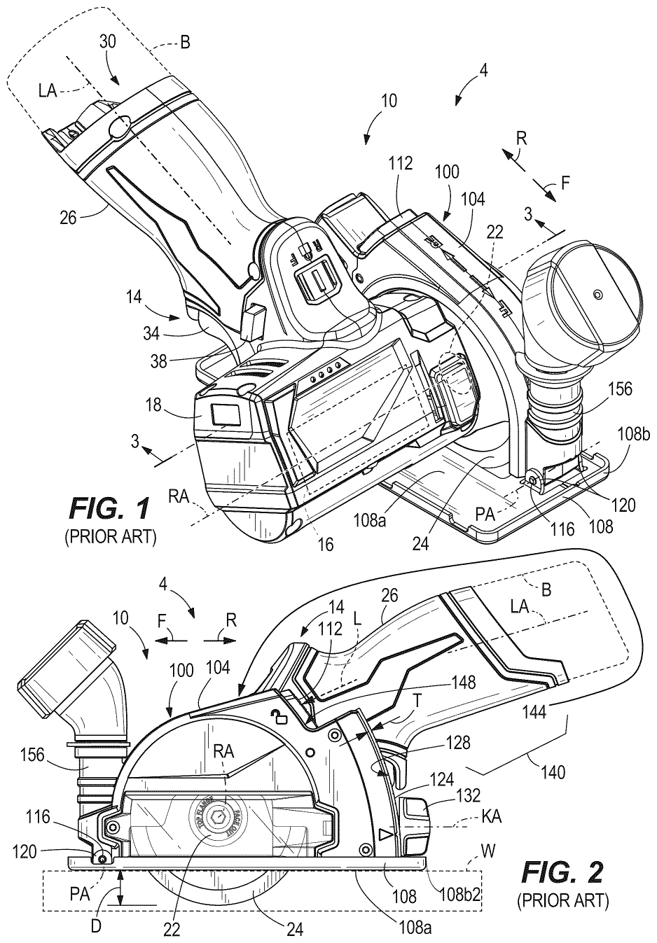

A pin 116 pivotably mounts the shroud body 104 to the shoe 66, permitting adjustment of a cutting depth D (FIG. 2) of the cutting disk 24 below the shoe 66. The shroud body 104 is pivotable relative to the shoe 66 about a pivot axis PA along which the pin 116 extends. The pin 116 is supported by a pair of pin supports 120 on either side of the shoe 66. In the illustrated embodiment, the pivot axis PA of the shroud body 104 is forward of the rotation axis RA of the motor 16 and the arbor 22 with respect to the typical forward advancing direction F, and the pivot axis PA is generally parallel to the rotation axis RA. In other embodiments, the pivot axis PA may be behind or otherwise oriented relative to the rotation axis RA with respect to the typical forward advancing direction F.

The shroud 100 further includes a depth adjustment bracket 124 coupled to and extending upwardly from the shoe 108. The depth adjustment bracket 124 of the shroud 100 is arcuately curved relative to the pivot axis PA such that as the shroud body 104 is pivoted about pivot axis PA, a depth guide surface 128 of the shroud body 104 slides along the depth adjustment bracket 124. The depth adjustment bracket 124 defines a thickness T extending towards the pivot axis PA in a direction generally perpendicular to the rotation axis RA.

A retention knob 132 (or other retention device) adjacent the depth guide surface 128 is movable with the shroud body 104 along a slot 136 (FIG. 4) of the depth adjustment bracket 124. The retention knob 132 is selectively actuatable to secure the shroud body 104 to the depth adjustment bracket 124 at a desired cutting depth D and is capable of being disengaged to permit pivoting movement of the shroud body 104 relative to the depth adjustment bracket 124. The illustrated retention knob 132 is coupled to a threaded fastener that is engageable with a threaded bore 134a of an upstanding portion 134 of the shroud body 104. The retention knob 132 is rotatable between locked and unlocked positions about a knob axis KA to provide firm frictional contact between the retention knob 132 and the depth adjustment bracket 124. The knob axis KA of the shroud 100 extends at least partially in a forward-reverse direction (e.g., left to right as viewed in FIG. 2). The knob axis KA may be raised, lowered, or tilted relative to the shoe 108 depending on the cutting depth D. In the position of FIG. 2, the retention knob 132 is positioned above a rear sidewall 108b2 (FIG. 2) of the shoe 108, and the retention knob 132 extends beyond a projection of the shoe 108 (in a direction upward as viewed in FIG. 2) in the reverse direction R. The retention knob 132 is accessible by a user from behind the shroud body 104. In other embodiments, different types of locking mechanisms may replace the retention knob 132.

As viewed from a side of the shroud 100 (i.e., in a direction parallel to the rotation axis RA, FIG. 2), the shroud body 104 defines an exterior profile 140 including the depth guide surface 128, an upper shroud body surface 144 positioned above the guard 42 relative to the cutting disk 24, and a latch surface 148 recessed from the upper shroud body surface 144. The latch 112 is engageable by a user depressing the latch 112 in a latch advancing direction L generally parallel to the longitudinal axis LA and towards the pivot axis PA. Depression of the latch 112 unlocks the shroud 100 from the guard 42, whereafter, an operator may lift the shroud 100 away from the guard 42. As shown in FIG. 4, the latch 112 is biased by a spring 112a (e.g., a compression spring) to a closed position whereby an end 112b of the latch 112 engages an aperture 42a near a rear end of the guard 42. The guard 42 is generally semi-circular about the rotation axis RA, and the front end of the guard 42 terminates at an end 42b. The shroud body 104 includes a shoulder 152 configured to abut the end 42b of the guard 42 when the shroud 100 is secured on the guard 42.

The shroud body 104 further includes an exhaust port 156 from which debris created during a workpiece cutting operation is discharged. The exhaust port 156 is attachable to a vacuum source (not shown). Furthermore, debris may be expelled from the exhaust port 156 and/or a vacuum attachment when the cutting disk 24 is driven in the forward direction by the motor 216 and the reverse direction by the motor 16. The exhaust port 156 may be coupled to a vacuum attachment to facilitate a rotatable connection between a vacuum tube and the exhaust port 156.

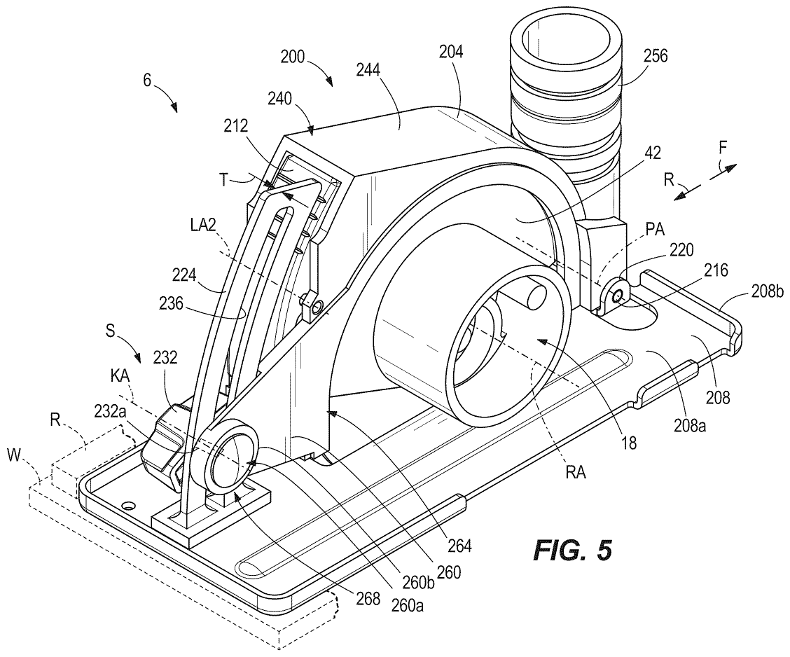

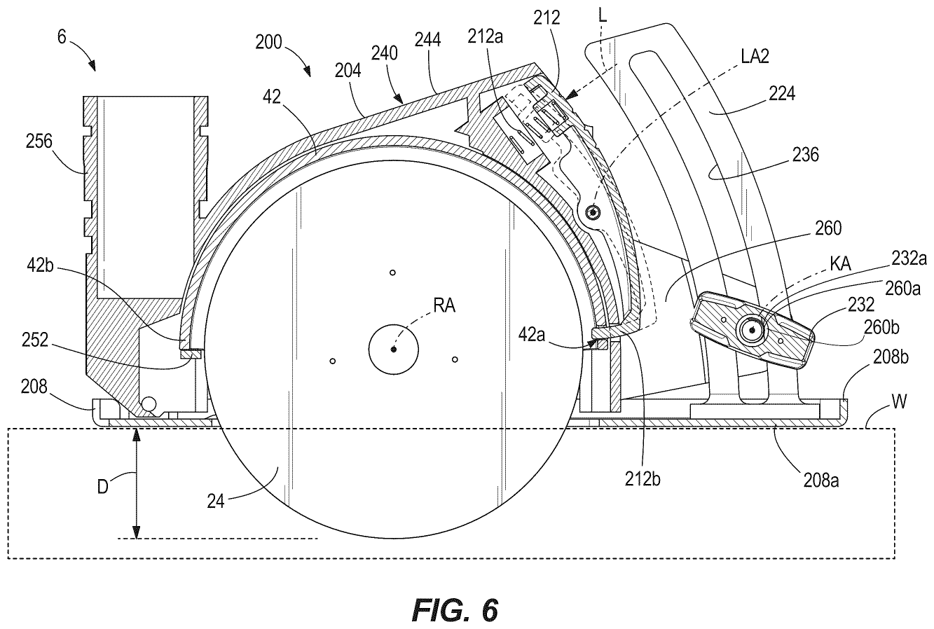

FIGS. 5-7 illustrate a shroud 200 according to an embodiment of the invention and as part of a cut-off tool and shroud assembly 6 including the cut-off tool 10. The shroud 200 may be connectable to the same cut-off tool 10 as the shroud 100. Like features between the shroud 100 and the shroud 200 are represented with like reference numbers plus “100”. The shroud 200 is illustrated as connected to a guard 42, and a motor portion 18 of an exemplary attached cut-off tool 10, which is partially illustrated. As illustrated in FIG. 6, the shroud 200 may include a latch 212 biased by a spring 212a, with the latch 212 being pivotably supported on the shroud body 204 about a latch axis LA2. The latch axis LA2 may be parallel to the rotation axis RA of the cutting disk 24. Differences between the shroud 200 and the shroud 100 are discussed below.

The depth adjustment bracket 224 of the shroud 200 is oriented with its slot 236 configured to engage the retention knob 232 with the retention knob 232 with its knob axis KA extending parallel to the rotation axis RA of the cutting disk 24. The depth adjustment bracket 224 projects in a direction generally perpendicular from the shoe 208. The depth adjustment bracket 224 defines a thickness T extending parallel to the rotation axis RA (i.e., between lateral sides of the shoe 208). The depth adjustment bracket 224 is arcuately curved relative to the pivot axis PA such that as the shroud body 204 is pivoted about the pivot axis PA, the retention knob 232 slides along the slot 236 of the depth adjustment bracket 224.

In contrast to the depth guide surface 128 of the shroud 100, the shroud 200 includes a lever arm 260 extending from the shroud body 204 between the shroud body 204 and the depth adjustment bracket 224. The lever arm 260 includes a proximal end 264 coupled to the shroud body 204 and an opposite distal end 268 coupled to the retention knob 232. The lever arm 260 may be either integrally formed with or otherwise coupled to the shroud body 204. As described above regarding the retention knob 132, the retention knob 232 is rotatable about its knob axis KA to selectively adjust or secure the cutting depth D of the cutting disk 24 relative to the shoe 208. The retention knob 232 includes a threaded shank 232a that is received in a corresponding threaded bore 260a within a boss 260b protruding from the lever arm 260 in a direction along the knob axis KA. The threaded connection between the threaded shank 232a and the threaded bore 260a permits the retention knob 232 to be tightened or loosened relative to the depth adjustment bracket 224 therefore increasing or decreasing the clamping force applied to the depth adjustment bracket 224.

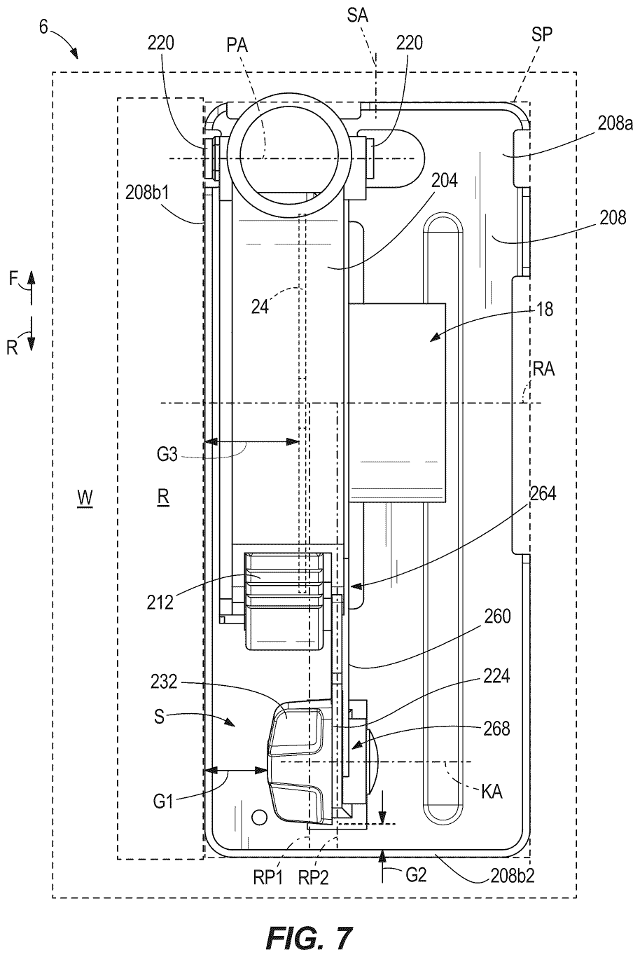

FIG. 7 illustrates a top view of the cut-off tool and shroud assembly 6 in a flush cut operation whereby a lateral sidewall 208b1 (i.e., a left sidewall as viewed in FIG. 7) of the shoe 208 is guided along a straight edge provided by a ruler R (or other guide) to make a corresponding straight cut in the workpiece W. FIG. 7 further illustrates components of the shroud 200 as being within a shoe profile SP defined by a perimeter of the shoe 208. The shoe profile SP is defined in a frame of reference parallel with the workpiece W with the shoe supported on the workpiece W. In other words, the shoe profile SP defines a plane generally coplanar with a surface of the workpiece W upon which the shoe 208 rests. The shoe profile SP is generally defined by a length and a width of the shoe 208 but not a thickness thereof. The shoe profile SP is generally coplanar with a length and a width of the ruler R. For example, the retention knob 232 is positioned entirely within the profile of the shoe 208. The retention knob 232 is laterally spaced from an outer periphery of the shoe 208 (e.g., the lateral sidewall 208b1) by gap G1. The gap G1 permits the lateral side of the shoe 208 to abut the ruler R without interference from the retention knob 232. The retention knob 232 is also longitudinally spaced (in front to rear direction, up and down as viewed in FIG. 7) from a rear sidewall 208b2 of the shoe 208 by gap G2. Since the retention knob 232 is positioned within a profile of the shoe 208, the longitudinal tool profile at the shoe 208 is reduced, permitting the shoe 208 to be maneuverable in tight spaces. The lever arm 260 is positioned inboard of the depth adjustment bracket 224, or in other words, closer in a lateral direction parallel to the rotation axis RA to a central longitudinal shoe axis SA defined by the shoe 208. By locating the lever arm 260 connecting the shroud body 204 and the depth adjustment bracket 224 inboard of the depth adjustment bracket 224, a side flush cut offset G3 measured parallel to the rotation axis RA between the lateral sidewall 208b1 of the shoe 208 against the ruler R and a side of the cutting disk 24 may be decreased. By reducing the side flush cut offset G3, the cut-off tool and shroud assembly 6 can be used to make linear cuts in workpieces W closer to rulers R (or other similar structure).

FIG. 7 illustrates relative positions of the shroud body 204, latch 212, depth adjustment bracket 224, and retention knob 232. In the illustrated embodiment, the latch 212 is positioned behind the shroud body 204, and the retention knob 232 is positioned behind the latch 212. A reference plane RP1 perpendicular to the rotation axis RA intersects each of the shroud body 204, the latch 212, and the retention knob 232. In the illustrated embodiment, the lever arm 260 is positioned behind the shroud body 204, and the depth adjustment bracket 224 is positioned at least partially behind the lever arm 260. As shown in FIG. 5, the lever arm 260 may have variable thickness in a direction parallel to the rotation axis RA such that a thicker portion of the lever arm 260 is positioned between the shroud body 204 and the depth adjustment bracket 224. In other embodiments, the lever arm 260 need not be fully axially aligned with the depth adjustment bracket 224. In the illustrated embodiment, a thinner portion of the lever arm 260 is positioned laterally adjacent the depth adjustment bracket 224. As viewed in FIGS. 5 and 7, the thinner portion of the lever arm 260 is positioned laterally to the right of the depth adjustment bracket 224. In a direction along the knob axis KA, the retention knob 232 and the lever arm 260 sandwich the depth adjustment bracket 224 therebetween. In the illustrated embodiment, the retention knob 232 is closer to the cutting disk 24 and ruler R than the lever arm 260. However, other arrangements may locate the lever arm 260 closer to the cutting disk 24 and ruler R than the retention knob 232. The illustrated arrangement allows the depth adjustment bracket 224 to intrude minimally on space that a user could otherwise use to grasp the handle 26. In other embodiments, the lever arm 260 may be positioned to the left of or within the bounds of (e.g., within the lateral sides of) the depth adjustment bracket 224. A reference plane RP2 perpendicular to the rotation axis RA intersects each of the shroud body 204, the lever arm 260 (more specifically, the thicker portion thereof), and the depth adjustment bracket 224.

The arrangement and orientation of the depth adjustment bracket 224 provide a structurally robust bracket that is resistant to bending deflection. Reorienting the thickness T of the depth adjustment bracket 224 geometrically allows more material to contribute to a bending moment of inertia to inhibit bending deflection when forces and/or moments are applied to the depth adjustment bracket 224 at locations spaced from the shoe 208. Issues relating to bent depth adjustment brackets such as misalignment with the shroud body (e.g., shroud body 104) may be minimized. Further, a user may be permitted access to the retention knob 232 from a lateral side S of the cut-off tool and shroud assembly 6.

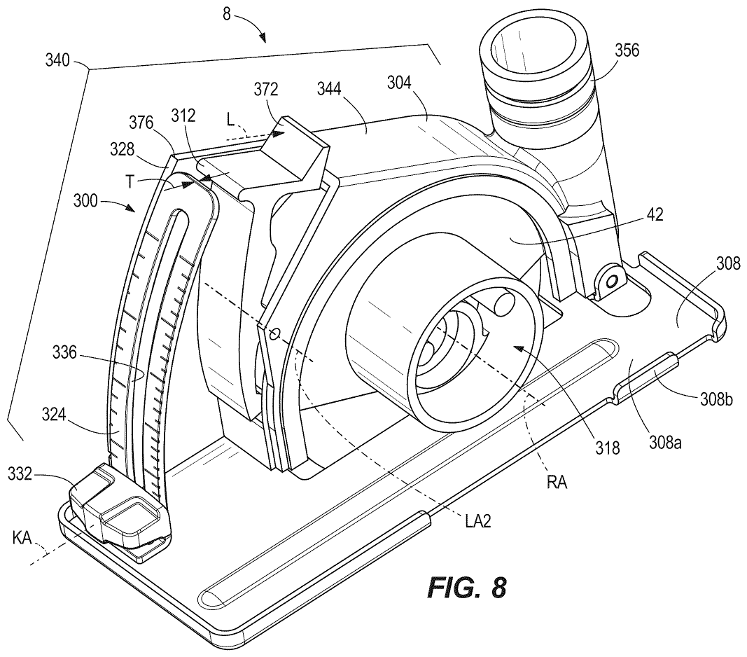

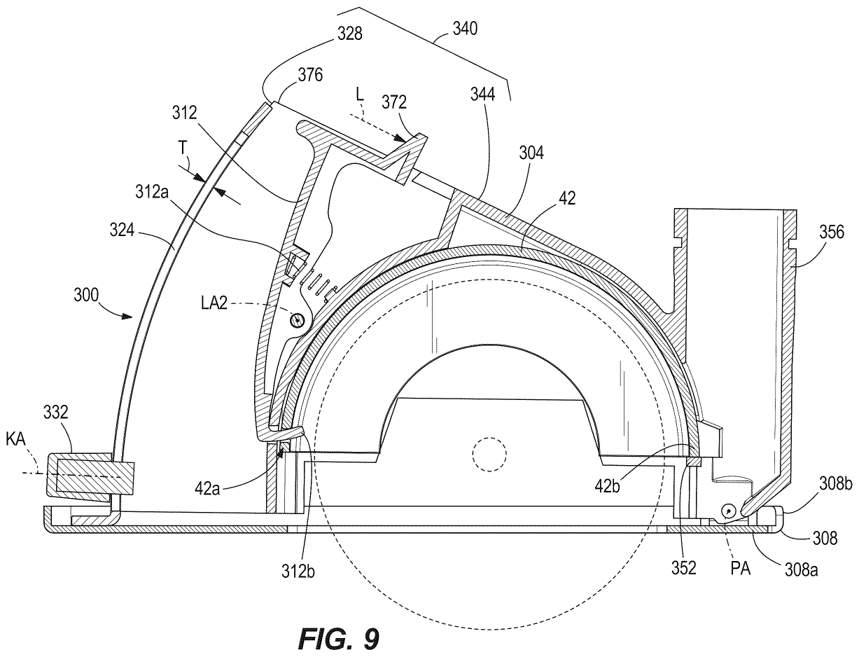

FIGS. 8-9 illustrate a shroud 300 according to another embodiment of the disclosure and as part of a cut-off tool and shroud assembly 8 including the cut-off tool 10. The shroud 300 may be connectable to the same cut-off tool 10 as the shroud 100. Like features between the shroud 100 and the shroud 300 are represented with like reference numbers plus “200”. The shroud 300 is illustrated as connected to a guard 42, and a motor portion 18 of an exemplary attached cut-off tool 10 is partially illustrated. The shroud 300 may include a latch 312 biased by a spring 312a and pivotably supported on the shroud body 304 about a latch axis LA2. The latch axis LA2 may be parallel to the rotation axis RA of the cutting disk 24. Like the depth adjustment bracket 124 of the shroud 100, the depth adjustment bracket 324 defines a thickness T extending towards the pivot axis PA in a direction generally perpendicular to the rotation axis RA. Differences between the shroud 300 and the shroud 100 are discussed below.

As viewed from a side of the shroud 300 (i.e., in a direction parallel to the rotation axis RA, FIG. 9), the shroud body 304 defines an exterior profile 340 including a depth guide surface 328 and upper shroud body surface 344 positioned above the guard 42 relative to the cutting disk 24. The upper shroud body surface 344 generally represents an uppermost surface of the shroud body 304 as viewed in a frame of reference parallel with the cutting disk axis. The latch 312 is engageable by a user depressing the latch in a latch advancing direction L generally along the upper shroud body surface 344 and towards the pivot axis PA. In contrast to the recessed latch surface 148 of the shroud 100, the latch 312 of the shroud 300 includes an actuator 372 that extends (i.e., protrudes) beyond the upper shroud body surface 344. The actuator 372 is accessible at a location above the shroud body 304 such that sufficient space may be present between the handle portion 26 and the actuator 372. The actuator 372 is configured to receive input force along latch advancing direction L to facilitate movement of the latch 312 to its unlocked position whereby the shroud 300 is removable from the guard 42.

In contrast with the recessed latch surface 148 of shroud 100, in the shroud 300, the upper shroud body surface 344 and the depth guide surface 328 meet at a shared edge 376. The depth adjustment bracket 324 extends from the shoe 308 to the shared edge 376. As a result, a range of adjustment for the cutting depth D of the shroud 300 may be expanded (by increasing an upper bound of the range in comparison with that of the shroud 100) by the elongated depth adjustment bracket 324.

Although the invention has been described in detail with reference to certain preferred embodiments, variations and modifications exist within the scope and spirit or one or more independent aspects of the invention as described.

Various features of the invention are set forth in the following claims.

What is claimed is:

1. A cut-off tool and shroud assembly comprising:
a cut-off tool including
a motor housing in which an electric motor is received,
a pistol-grip handle extending from the motor housing in a transverse direction,
an arbor rotatably supported by the motor housing,
a cutting disk attachable to the arbor and rotatable about a cutting disk axis, and
a guard surrounding an upper portion of the cutting disk; and
a shroud coupled with the guard, the shroud including
a shoe configured to support the shroud on a workpiece, a periphery of the shoe defining a shoe profile in a frame of reference parallel with the workpiece with the shoe supported on the workpiece,
a depth adjustment bracket coupled to the shoe,
a shroud body engageable with and surrounding the guard, the shroud body being pivotably coupled to the shoe about a pivot axis to adjust a cut depth of the cutting disk below the shoe, and
a lever arm extending from the shroud body between the shroud body and the depth adjustment bracket;
wherein the lever arm and the depth adjustment bracket are positioned entirely within the shoe profile.

2. The cut-off tool and shroud assembly of claim 1, wherein the depth adjustment bracket is positioned within the shoe profile and in alignment with the shroud body such that a reference plane perpendicular to the cutting disk axis intersects both the shroud body and the depth adjustment bracket.

3. The cut-off tool and shroud assembly of claim 2, wherein the reference plane intersects at the lever arm.

4. The cut-off tool and shroud assembly of claim 1, wherein the shroud body and the lever arm are pivotable about the pivot axis relative to the shoe, and wherein the depth adjustment bracket is arcuately curved relative to the pivot axis.

5. The cut-off tool and shroud assembly of claim 1, wherein the depth adjustment bracket defines a thickness extending parallel to the cutting disk axis.

6. The cut-off tool and shroud assembly of claim 1, wherein the shroud further comprises a retention device selectively actuatable to secure the lever arm and the shroud body with the depth adjustment bracket, the retention device being oriented along a retention device axis extending parallel to the cutting disk axis.

7. The cut-off tool and shroud assembly of claim 6, wherein in a direction along the retention device axis, the retention device and the lever arm sandwich the depth adjustment bracket therebetween.

8. The cut-off tool and shroud assembly of claim 6, wherein the lever arm is positioned inboard of the depth adjustment bracket.

9. The cut-off tool and shroud assembly of claim 6, wherein the retention device is positioned within the shoe profile and laterally spaced from an outer periphery of the shoe by a gap.

10. The cut-off tool and shroud assembly of claim 1, wherein the lever arm has variable thickness in a direction parallel with the cutting disk axis.

11. The cut-off tool and shroud assembly of claim 10, wherein the lever arm defines a thicker portion and a thinner portion, and the thinner portion is positioned laterally adjacent the depth adjustment bracket in a direction parallel to the cutting disk axis.

12. The cut-off tool and shroud assembly of claim 1, wherein the shroud body includes an exhaust port attachable to a vacuum source to remove debris created during a workpiece cutting operation.

13. A cut-off tool and shroud assembly comprising:
a cut-off tool including
a motor housing in which an electric motor is received,
a pistol-grip handle extending from the motor housing in a transverse direction,
an arbor rotatably supported by the motor housing,
a cutting disk attachable to the arbor and rotatable about a cutting disk axis, and
a guard surrounding an upper portion of the cutting disk; and
a shroud coupled with the guard, the shroud including
a shoe configured to support the shroud on a workpiece, a periphery of the shoe defining a shoe profile in a frame of reference parallel with the workpiece with the shoe supported on the workpiece,
a depth adjustment bracket coupled to the shoe,
a shroud body engageable with and surrounding the guard, the shroud body being pivotably coupled to the shoe about a pivot axis to adjust a cut depth of the cutting disk below the shoe, and
a retention device selectively movable between a locked position, in which the shroud body is secured relative to the shoe, and an unlocked position, in which the shroud body is pivotable relative to the shoe;
wherein the retention device is positioned entirely within the shoe profile.

14. The cut-off tool and shroud assembly of claim 13, wherein the shroud further includes a latch engageable with the guard to secure the shroud body to the cut-off tool.

15. The cut-off tool and shroud assembly of claim 14, wherein the retention device is positioned in alignment with the latch such that a reference plane perpendicular to the cutting disk axis intersects both the latch and the retention device.

16. The cut-off tool and shroud assembly of claim 13, wherein the retention device comprises a retention knob including a threaded shank received in a threaded bore within a boss of a lever arm of the shroud body, and wherein the retention knob is laterally spaced from an outer periphery of the shoe by a gap.

17. A cut-off tool and shroud assembly comprising:
a cut-off tool including
a motor housing in which an electric motor is received,
a pistol-grip handle extending from the motor housing in a transverse direction,
an arbor rotatably supported by the motor housing,
a cutting disk attachable to the arbor and rotatable about a cutting disk axis, and
a guard surrounding an upper portion of the cutting disk; and
a shroud coupled with the guard, the shroud including
a shoe configured to support the shroud on a workpiece,
a depth adjustment bracket coupled to the shoe,
a shroud body engageable with and surrounding the guard, the shroud body defining an uppermost surface as viewed in a frame of reference parallel with the cutting disk axis, and
a latch movably coupled to the shroud body, the latch including an actuator extending above the uppermost surface of the shroud body, the actuator configured to receive an input force to move the latch to an unlocked position in which the shroud is removable from the guard.

18. The cut-off tool and shroud assembly of claim 17, wherein the latch is pivotable about a latch axis that is parallel with the cutting disk axis.

19. The cut-off tool and shroud assembly of claim 18, wherein the shroud further comprises a spring that biases the latch to a locked position in which the shroud is locked to the guard.

20. The cut-off tool and shroud assembly of claim 17, wherein the shroud body is pivotable about a pivot axis relative to the shoe, wherein the depth adjustment bracket is arcuately curved relative to the pivot axis, and wherein the depth adjustment bracket defines a thickness extending toward the pivot axis in a direction generally perpendicular to the cutting disk axis.
